(19) United States
(12) Patent Application Publication
(10) Pub. No.: US 2025/0044866 A1
(43) Pub. Date: Feb. 6, 2025

(54) ARTIFICIAL INTELLIGENCE BASED INTELLIGENT VIRTUAL REALITY NAVIGATION SYSTEM FOR ENHANCED USER EXPERIENCE

(71) Applicants: Nithya Rekha SIVAKUMAR, Riyadh (SA); Thangavel MURUGAN, Al Ain (AE); Avinash KUMAR, Noida (IN); Rincy MERLIN MATHEW, Abha (SA); Praveen RANI VENKATA SATYA, Madhapur (IN); Vijay MOHAN, Krishankoil (IN); Ravi Teja AIDA, Madhapur (IN); Prabakar DEVADASS, Coimbatore (IN); Mohit TIWARI, Delhi (IN); Baskar KANDASAMY, Trichy (IN); Sangeetha SUBRAMANIAM, Trichy (IN)

(72) Inventors: Nithya Rekha SIVAKUMAR, Riyadh (SA); Thangavel MURUGAN, Al Ain (AE); Avinash KUMAR, Noida (IN); Rincy MERLIN MATHEW, Abha (SA); Praveen RANI VENKATA SATYA, Madhapur (IN); Vijay MOHAN, Krishankoil (IN); Ravi Teja AIDA, Madhapur (IN); Prabakar DEVADASS, Coimbatore (IN); Mohit TIWARI, Delhi (IN); Baskar KANDASAMY, Trichy (IN); Sangeetha SUBRAMANIAM, Trichy (IN)

(21) Appl. No.: 18/923,516

(22) Filed: Oct. 22, 2024

(51) Int. Cl. G06F 3/01; G01S 17/894; G06N 3/02

(52) U.S. Cl. CPC G06F 3/013; G01S 17/894; G06F 3/015; G06F 3/016; G06F 3/017; G06N 3/02

(57) ABSTRACT

The present invention generally relates to a virtual reality (VR) navigation system using artificial intelligence (AI), thus enabling providing of individualized and context-aware navigation experience in VR environments. It consists of an AI-inclusive central processing unit (CPU) that receives and processes real-time data from multiple hardware sensors deployed in a wearable VR headset, e.g., inertial measurement units (IMUs), eye-tracking sensors, biometric ones. This is AI-driven CPU that dynamically changes the navigation path and sensory outputs such as visual, audio, haptic based on user input/interaction & environmental context. It consists of a hand-held controller with numerous input interfaces and a wireless communication module, enabling it to be easily linked or integrated into several VR applications.

### FIELD OF INVENTION

The present invention generally pertains to the field of virtual reality (VR) systems and more specifically, an AI driven intelligent navigation system that improves user experience in a virtual environment.

### BACKGROUND OF THE INVENTION

Virtual reality has gained importance in different areas such as Gaming, Education & training and Health care. In the case of more complex virtual environments, such traditional VR navigation systems are often not sufficient because they depend on predefined paths or manual grasping actions that can be cumbersome and hard to operate. Traditional approaches tend to cause disorientation, cognitive overload and user dissatisfaction.

The recent advances in AI and machine learning have the potential to transform VR navigation into systems that can intelligently understand user's behaviour in a virtual environment. To address the issues faced by current VR navigation technologies, we present an AI-driven solution in this invention for more comfortable and user-friendly experience with a personalized and context-aware navigation.

VR has come a long way in the last few decades and found its uses from gaming to education, healthcare, professional training and others. At its heart, VR is about creating an experience that places users inside a virtual world-one that either mirrors the real-world around us or takes it to heights beyond anything in reality. But as VR has become more high-tech, so too have the challenges for navigation of these virtual spaces-issues which traditional methods haven't been able to effectively solve.

Initially, Navigation in VR was restricted to basic control inputs such as joystick controllers or keyboard and mouse setups that enabled the user simple movements through virtual spaces. The input solutions needed to deliver something beyond purely functional controllers, into a more intuitive and tangibly integrated experience in VR. This means that the actual input schemes are more awkward and less intuitive for people who aren't used to game or computer interfaces has a learning curve. This often led to a steep learning curve and barrier of entry for new users which ultimately limited the case vs. usability question that made it difficult to widespread adoption in VR technology.

As VR matures, the sophistication of its virtual environments will match this advancement in technology. As these environments grew, they also become much more complex and required a higher level of interaction with the world around us creating problems that became harder to solve using traditional navigation solutions. In a bid to address this problem, common approaches for providing spatial navigation have emerged such as teleportation-based locomotion systems where the user aims at an area within the VR simulation and instantly teleports there. While this completely solves some of the traditional movement control problems, like increasing motion sickness due to artificial locomotion it also raises a new set of issues. Teleporting can disorient the user, and it is done so out of immersion. Also, when an environment calls for precise movement or interaction (e.g., in VR simulations used to train professionals) teleporting can be inadequate and inaccurate.

Room-scale tracking systems have been another major step forward in VR navigation. Most tracking systems require you to move through a play area in order for your actions to be reflected within the virtual world. Room-scale offers a very immersive experience, and works well when navigating smaller or confined virtual worlds. Nonetheless, the effectiveness of this technique is constrained to how much physical space there is in a user's surroundings. The truth is that few Valve Index users have an entire room to dedicate for big VR play, and even those who do may find themselves bumping into a lot of walls because the size scale of their virtual world surpasses what they can really afford. This result in a fragmented experience and users are forced to continually return them or use some other type of navigation around large virtual spaces.

To overcome the limitations of room-scale VR, some applications have incorporated artificial locomotion, allowing users to walk or run by simply using a thumb stick built into their hand controllers or other input devices. But, this often results in enhance the motion sickness problem since visual stimuli and physical sensation of user are not consistent. When a user feels different from what they see, it can cause discomfort and nausea (in the same way that motion sickness causing driving while reading or playing on your phone). This has been a major hurdle when it comes to acceptance of VR in use cases that require longer durations such as training simulations or virtual workplaces.

As with all of these obstacles, a wide field-of-view and low-latency system would help to reduce the inconvenience, so there have been numerous tries at better VR interface systems that can provide even more immersion while still being intuitive and accessible. And the integration of eye-tracking tech is one way for the system to infer where a user may be looking, offering hints as appropriate. Though it holds a lot of promise, this is still fairly new technology and has not fully taken mainstream yet. However, the idea also raises a number of concerns about privacy and data security, as eye-tracking data is personal and can be revealing.

Other developing options incorporate the use of gesture recognition systems, where users can navigate through the virtual environment using natural hand movements or body expressions. Unfortunately, gesture recognition systems are not always reliable; they may need certain conditions or environments to work improperly. They can also be susceptible to gesture misinterpretation, which may cause frustration and a poor user experience.

However, many current VR navigation solutions share a common problem that they are very much one-size-fits-all. Most systems are not user-dependent and, hence disregard individual differences of the users like experience levels or physical abilities. This lowered level of personalization often leads to experiences where the navigation systems either overloads or leaves under-utilized human capabilities. Someone new to the tool might feel overwhelmed by a very complex navigation system where as an experienced individual would be left wanting more advanced options.

Notwithstanding, the majority of existing VR navigation interfaces are not contextually aware to enable efficient adaptation in virtual reality space. They tend to think of every virtual space the same, not considering how complex something is—or what someone wants out of it (PERI)? This static approach may undermine the effectiveness of VR for tasks such as medical training where precise context-mediated navigation through human anatomy is necessary or in educational environments, which would have benefited by providing a system to navigate user's thorough learning paths that adapt as their understanding increase.

One obvious use case is that artificial intelligence (AI) could help to mitigate some of the aforementioned shortcomings of existing systems for navigating VR. AI will allow for more dynamic, personalized VR navigation. Using AI, it can analyse user interaction in real-time and adjust the navigation experience according to individual preferences or requirements of each end-user. One possible way in which this could be implemented is the AI noticing that a user seems unable to navigate through a more complex environment and stepping or reducing complexity of navigation up its conversational support. Or, for a user who likes to discover things on her own, the AI could reduce guidance and enable exploration.

In addition, AI will increase the awareness of navigation system. Each time the user performs a navigation action, or moves from one point to another in space within VR experience (room, area . . . ) would learn about context of virtual environment—are there obstacles that should be avoided; what is where and why it matters for current ‘quest’ etc. This information can help AI construct more efficient way/path how the users navigate surroundings which results with better efficiency or engagement. Instead, in a virtual museum tour, the AI might make recommendations to the user about other exhibits they would be interested based on their viewing history or recommend that someone should practice certain skills if it was identified through VR training simulation.

### SUMMARY OF THE INVENTION

The current invention describes an AI context aware virtual reality navigation system that is capable to adapt the user experience by providing dynamic and real-time navigation within 3D worlds. It consists of a VR navigation tool that incorporates AI techniques which assess user behaviour, preferences and environmental concerns so as to adapt the course of movement on an on-going basis.

This AI-based setup grants a processing unit that maintains real-time data capturing and decision making, supplemented by sensory input module to observe user activities as well as environmental facilitation, ending in feedback mechanism which is responsible for iteratively refining navigation based on the response of users. The system has been built to work well throughout VR applications, so that users can experience interactivity in a more naturally and consistently.

The main objective of the present invention relates to a novel intelligent virtual reality navigation technology implemented through an AI-based intuitive and effective navigation system in the context that could considerably improve user experience by providing VR-adaptive, audience-relevant and situation-sensitive path finding inside Virtual Reality. The task of the invention is to solve these above problems, and provide upper-level VR navigation rules (without motion sickness, not lost in space due to disorientation bottoms or because manual control schemes are difficult for new users with virtual reality knowledge barriers) based on action intelligent decision adjusts user's behaviour preferences specifically according usually context after standing at a certain time.

Yet another object of the invention is to provide a navigation system that has high degree of intuitiveness and user-friendliness for users with different levels of experience. Through AI techniques—such as the ability to dissect and learn from real-time user interactions—the system aims for a frictionless navigation experience that's intuitive and immersive, requiring little cognitive overhead on behalf of users so they can focus more directly on content or virtual environment tasks.

The invention further aims to improve the usability and overall performance of VR apps in different domains—education, training healthcare and entertainment. The invention provides an approach that can be used to develop the next generation of navigation system implementation which will improve learning outcomes, training effectiveness and increase overall user satisfaction by intuitively guiding users through highly complex virtual environments based on their goals and skill levels.

This lets applicants easily deploy this solution into wide range of VR applications and environments, which are also scalable. The system is based on AI, and it has the flexibility to take different virtual space types—from small scale such as a classroom or large-scale remote simulation of cities, natural resort park like ICLUSI)—as input. The broad application of this navigation system makes it different from many others, and also allows for its customizability to the specific requirements/environments needed by end users.

Another angle the invention wants to solve is user fatigue issue and health problem VR applications users experience after hours of using a Virtual Reality (VR). More importantly, with the infusion of AI-driven adaptive navigation into your system it would be set on a path that simplifies all movement and interaction patterns to minimize unnecessary exertion, thereby reducing motion sickness related consequences and preserving comfort for longer VR sessions.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for providing an AI-based intelligent virtual reality navigation system; and

FIG. 2 provides flow chart of a method for providing AI-based intelligent virtual reality navigation to enhance user experience.

### DETAILED DESCRIPTION OF THE INVENTION

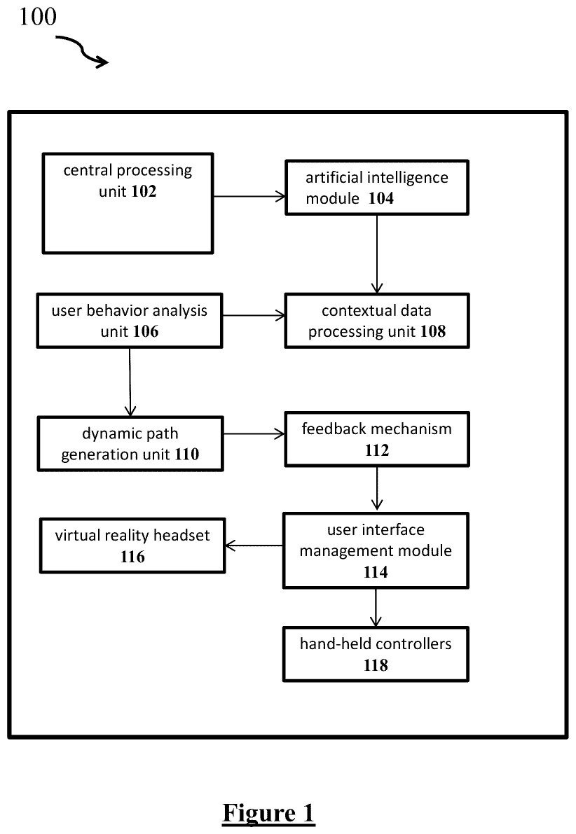

Referring to FIG. 1, a block diagram of a system for providing an AI-based intelligent virtual reality navigation system to enhance user experience, the system comprising: a central processing unit (CPU) 102 configured to execute and manage operations within the system; an artificial intelligence module 104 operatively connected to the CPU and configured to analyze real-time user behavior and environmental data within the virtual reality environment; a user behavior analysis unit 106 operatively connected to the artificial intelligence module, the unit comprising motion sensors, gaze trackers, and interaction data capture components, wherein the user behavior analysis unit is configured to monitor and record the user's movements, gaze direction, and interactions within the virtual environment; a contextual data processing unit 108 operatively connected to the artificial intelligence module, the unit comprising environmental sensors and spatial mapping techniques configured to analyze the virtual environment's layout, object distribution, and ambient conditions; a dynamic path generation unit 110 operatively connected to the artificial intelligence module, configured to create and update in real-time, personalized navigation paths based on the analyzed user behavior and contextual data; a feedback mechanism 112 operatively connected to the dynamic path generation unit, comprising biometric sensors and user input interfaces configured to monitor user satisfaction and feed data back into the artificial intelligence module for continuous adaptation of the navigation strategy; and a user interface management module 114 operatively connected to the CPU, comprising display generation and control interfaces configured to present the virtual reality environment to the user, adjusting visual and interactive elements based on user preferences and real-time contextual analysis.

In an embodiment, the artificial intelligence module 104 further comprises machine learning techniques configured to learn from historical user interaction patterns, thereby enhancing the system's ability to predict user preferences and optimize future navigation paths within the virtual reality environment, the machine learning techniques being stored in a non-transitory memory component operatively connected to the CPU.

In an embodiment, the user behavior analysis unit 106 further comprises a neural network processor configured to process and analyze complex behavioral patterns in real-time, the neural network processor being operatively connected to the CPU and configured to communicate with the artificial intelligence module to refine the understanding of user intentions within the virtual environment.

In an embodiment, the contextual data processing unit 108 further comprises a three-dimensional (3D) spatial mapping sensor array configured to capture and analyze the spatial relationships between objects within the virtual environment, the 3D spatial mapping sensor array being operatively connected to the CPU and the artificial intelligence module to provide real-time updates to the dynamic path generation unit.

In an embodiment, the dynamic path generation unit 110 further comprises a path optimization processor configured to analyze potential navigation routes based on user behavior and environmental context, the path optimization processor being operatively connected to the artificial intelligence module and configured to dynamically adjust the user's navigation trajectory to avoid obstacles, minimize disorientation, and optimize the user's overall experience within the virtual environment.

In an embodiment, the feedback mechanism 112 further comprises a physiological monitoring unit, including heart rate monitors, eye movement trackers, and galvanic skin response sensors, the physiological monitoring unit being operatively connected to the CPU and the artificial intelligence module to provide real-time feedback on the user's physiological state, enabling the system to adjust navigation paths and environmental conditions to enhance user comfort and reduce stress during the VR experience.

In an embodiment, the user interface management module 114 further comprises a haptic feedback generator operatively connected to the CPU and configured to provide tactile feedback to the user through hand-held controllers, the haptic feedback generator being controlled by the artificial intelligence module to enhance the immersive quality of the navigation experience by simulating physical interactions with virtual objects.

In an embodiment, the central processing unit (CPU) 102 further comprises multi-core processor architecture, the multi-core processor architecture being configured to independently handle parallel processing tasks including user behavior analysis, contextual data processing, dynamic path generation, and user interface management, thereby ensuring real-time responsiveness and smooth operation of the AI-based intelligent virtual reality navigation system.

In an embodiment, the virtual reality headset 116 comprises integrated displays with a high refresh rate and wide field of view, operatively connected to the CPU and user interface management module, the displays being configured to present a stereoscopic view of the virtual environment, thereby enhancing the immersive quality of the navigation experience, and further comprising motion sensors embedded within the headset to track head movements and adjust the visual display accordingly.

In an embodiment, the hand-held controllers 118 further comprise inertial measurement units (IMUs) and force feedback mechanisms, operatively connected to the CPU and haptic feedback generator, the hand-held controllers being configured to allow the user to interact with virtual objects through gestures and button inputs, with the force feedback mechanisms providing resistance and tactile sensations corresponding to the virtual interactions, thereby enhancing the realism of the navigation experience within the virtual environment.

In an embodiment, the machine learning techniques are executed within a dedicated neural processing unit (NPU), configured to handle tensor operations by parallelizing the data across multiple cores, wherein the NPU processes real-time user interaction data by partitioning it into mini-batches, applying gradient-based optimization techniques to update navigation models without interrupting the system's primary processing tasks, and wherein the NPU directly communicates with the CPU through a high-speed bus, enabling continuous learning and path prediction adjustments based on dynamic changes in user behavior patterns.

In this embodiment, the machine learning techniques are executed within a dedicated neural processing unit (NPU), which is specifically designed to handle tensor operations. Tensor operations, fundamental to neural networks, are computationally intensive as they involve large-scale matrix multiplications and transformations. The NPU is configured to process these operations efficiently by parallelizing the data across multiple cores, allowing the system to process real-time user interaction data—such as movement, gaze direction, and virtual object interactions-without overwhelming the main CPU. The NPU breaks down this data into mini-batches, small segments of the total input, enabling gradient-based optimization techniques to operate continuously in real-time. By employing gradient descent, the system can adjust navigation models dynamically based on the user's behaviour as it evolves during the virtual reality session. Furthermore, the NPU communicates directly with the CPU through a high-speed bus, allowing the rapid exchange of data and ensuring that the AI-based system can adjust paths and provide personalized navigation without interrupting the main processing tasks. This architecture ensures continuous learning and path prediction adjustments, meaning the system can offer a smooth, uninterrupted experience even as the virtual environment or user behaviour changes. For example, if a user consistently looks in certain directions or interacts with specific virtual objects, the system can adjust the navigation paths to prioritize those areas or interactions in future sessions. This division of processing between the NPU and CPU ensures both efficiency and responsiveness in the virtual reality experience.

In an embodiment, the neural network processor operates using a specialized memory hierarchy that stores user movement and gaze data in a cache memory system, wherein said memory system is structured to pre-load relevant data chunks, reducing latency in real-time processing, wherein the processor first performs time-based segmentation of the user's movement data and applies a series of non-linear transformations through activation functions designed to detect subtle variations in user intent, including, slight head tilts or micro-gestures.

In this embodiment, the neural network processor is designed to enhance the efficiency of real-time processing by utilizing a specialized memory hierarchy. The processor's memory system includes a cache memory that temporarily stores user movement and gaze data, allowing for rapid access during critical processing stages. This cache is structured to pre-load relevant data chunks, which ensures that the most pertinent information, such as recent user movements or gaze shifts, is readily available for analysis, reducing latency and avoiding delays typically associated with fetching data from slower, main memory. By minimizing latency, the system is capable of delivering real-time feedback and making immediate adjustments in the virtual environment.

The neural network processor then processes this pre-loaded data by performing time-based segmentation, which involves dividing the user movement data into smaller time frames to capture moment-to-moment changes in behaviour. For instance, slight head tilts, eye movement, or hand gestures are segmented over time to identify patterns. The processor applies a series of non-linear transformations through activation functions like ReLU (Rectified Linear Unit) or Sigmoid functions. These transformations help detect subtle variations in user intent that may not be immediately obvious, such as micro-gestures (small finger movements) or slight shifts in head positioning that could indicate an intention to interact with specific virtual objects or navigate in a particular direction.

For example, if a user slightly tilts their head toward an object in the virtual environment, the system can interpret this as an intention to focus on or interact with that object. By using this specialized memory and processing approach, the neural network processor is able to make real-time adjustments based on these small variations, enabling a more intuitive and responsive virtual reality experience.

In an embodiment, the 3D spatial mapping sensor array uses structured light projection to create a high-density point cloud representation of the virtual space, wherein the array includes time-of-flight (ToF) sensors that measure the distance between objects by calculating the time delay of the reflected light, wherein the point cloud data is then processed by the contextual data processing unit, which applies a voxel-based filtering technique to eliminate noise from the point cloud, ensuring that only relevant environmental changes, including moving obstacles or altered lighting conditions, are fed to the dynamic path generation unit for real-time adjustment of user paths.

In this implementation, 3D spatial mapping sensor array is rated to generate high-density point cloud of structured light projection making an advanced model of the virtual space. Structured light does this by projecting a pattern of known light (like grids or dots) into the volume, and then reading how that projected structured sign became warped due to the shapes in the environment. In this version, all data can be transformed into what is referred to as a point cloud-a set of data points in space representing the surface(s) of objects. The sensor array has time-of-flight (ToF) sensors to improve the accuracy of distance measurements. This system works by determining the time of flight (time taken from point A to point B) and provides a distance between objects with users.

Processing the point cloud data generated involves firstly being passed through a contextual data processing unit which sanitizes raw information. The module employs a voxel-based filtering method, which splits the point cloud into tiny cubic volumetric units called “voxels.” The clean operation purifies the previously screened information, removing noise or unimportant data points (like sensor inaccuracies of light projection artifacts), leaving only important contextual details. For example, discarding static background elements such as foliage that does not influence navigational stability and favoring factors like moving objects or changing lighting only it the environment.

The modified point cloud data that only expresses important environmental changes are then sent to the dynamic path generation unit. With these real-time data at its disposal, the system modifies optimal navigating paths for a user according to newly emerging spatial information. This means that if a new obstacle appears in the user's path, such as a virtual object moving into their way like another HoloLens or non-head-worn device controller unexpectedly held up by someone standing right behind them (something i turn off when interacting with holograms) then Holo-Wayfinder can recalculate and adjust the navigation route to avoid it almost instantly. If the light changes, or brightens up momentarily at certain points of the track (like in forested areas) we may calculate a different course for safety and visibility within this Virtual Space. This continual real-time tweaking ensures the user receives seamless and natural movement through a living virtual world.

In an embodiment, the path optimization processor operates by analyzing navigation routes within a dedicated co-processor by segmenting the virtual environment into a graph of nodes and edges representing possible movement paths, wherein the processor applies heuristic weightings to each edge, prioritizing paths that minimize the user's visual confusion by avoiding complex intersections or sudden directional changes, and wherein the weightings are continuously updated based on incoming user data, ensuring real-time recalculations of optimal navigation routes in response to user behavior and environmental changes.

The path optimization processor in this embodiment is devoted to calculate and optimize navigation routes within the virtual environment. This involves breaking down the virtual environment to form a graph with nodes (that correspond to important locations or waypoints) and edges connecting these, representing possible paths as more on transitions between points. The system intrinsically models every possible manoeuvre in the virtual space by its graph structure.

The path optimization processor runs on a separate co-processor, so the main CPU is free to quickly respond in real time. The processor, on that note, assigns some heuristic weightings to the edges of the graph; these are going be used as a prioritization mechanism as for deciding what paths should priority over user. These weightings are based on the complexity of the path, comfort for users and weather conditions. For example, roads with multiple junctions or immediate changes in direction will be assigned weights between 1.01 to 5 (meaning they are less preferable) to keep the app user from blaming G6 Navigation when directions causes visual clutter and/or disorientation on their device due timing differences along lanes. The processor chooses instead smoother paths to enable more straightforward navigation and paradigms in order to have a good flow of the abstractions, providing an intuitive user interface.

These weightings are dynamically adjusted in real-time using live user data such as shifts of gaze, patterns of motion or changes within the environment (e.g. moving virtual objects). While engaging with the virtual world, the processor will re-examine this graph of nodes and edges—recalculating best path flows consistently. For instance, when a user hesitates or misreadings occur at an intersection, the system may change the heuristic weightings for that portion of path so that it is less likely to be chosen in future navigations. And in the event of some obstacle appears, or an approximation for like an area that seems to be more convenient by the user, or whatever than it accepts corrections.

The paths constructed by the plug-in are recalculated to account for what is in front of user and takes into consideration how they have changed their behaviour due a condition planed up stream, or between points systems already running. The path optimization processor adjusts itself to the user's interactions in real time improving overall experience of an XR environment with less disorientation and providing a more seamless, intuitive navigation through it.

In an embodiment, the physiological monitoring unit uses a series of embedded sensors within a wearable device, such as a wristband, to capture biometric data, including heart rate variability and galvanic skin response, wherein the data is processed using a fast Fourier transform (FFT) to isolate stress-related physiological signals, which are then cross-referenced with user behavior patterns, and wherein the artificial intelligence module uses this physiological data to dynamically adjust both the virtual environment and the navigation paths by modulating environmental lighting, sound intensity, and navigation speed to enhance user comfort and reduce stress.

This includes an integrated physiological monitoring unit which in the embodiment shown operates using embedded sensors, e.g. located on wearable sensing device disguised as a wristband for real-time processing of biometric information associated with user. Alongside these sensors, which are constantly recording vital physiological signals such as heart rate variability (HRV)—reflecting the emotional and physical state of users—or galvanic skin response (GSR) to determine fluctuations in conductivity on the surface of their skin correlating with stress levels. This enables the system to monitor changes of these metrics and correlates whether a user becomes emotionally well or experiences stress within their interaction with the virtual environment.

After collecting the biometric data, it is process using a Fast Fourier Transform (FFT), which is an technique that converts time-domain signals (like heart rate and skin conductance), into frequency domain. It is this metamorphosis that enables the apparatus to separate out individual marks of responses which suggest inexplicably higher or greater stress associated. Physiological Signals Misleading due To Control. For example, low frequency HRV oscillations and increased GSR frequencies have been shown to be markers of rising . . . for beginners stress. This concentration on specific frequencies allows the system to pinpoint signs of stress-related physiological conditions while ignoring other types of unrelated background noise.

System 102 further cross-references the processed physiological signals with user behaviour patterns, e.g., changes in gaze direction (e848), movement hesitation or interacting more with certain virtual objects. This relationship allows the system to understand if parts of a virtual environment are creating stress or discomfort. If a user is someone whose stress goes up when they walk through a particularly complicated or dark portion of the world, then stresses will peak at that point where physiological data aggregated on from different components and simultaneous to particular events would appear.

The processed and correlated physiological data is then utilized with an artificial intelligence module to make real-time adjustments not only in the virtual environment but also on how a user navigates. These adjustments can range from controlling environmental lighting (brightening or darkening virtual spaces), modifying sound intensity levels (lowering the volume of loud, sudden noises) to speeding up navigation movements as slow movement may cause boredom. If for instance the system determines that you're getting too frantic during a fast navigation sequence, it may make your action slower to keep things comfortable. The system may also flash-brighten the environment or simplify visual elements in cases where bad stress points are connected with a darkened area of physical clutter.

This embodiment keeps stress levels low and ensures that the virtual reality experience is responsive while at all times tracking user physiology, enhancing situational awareness provides higher immersion satisfaction by responding appropriately.

In an embodiment, the haptic feedback generator operates by receiving real-time input from the artificial intelligence module, which dynamically adjusts the intensity and type of haptic feedback based on user interactions, wherein the generator uses a piezoelectric actuator array embedded in hand-held controllers, wherein each actuator is independently controlled to simulate varying textures, forces, and resistances when the user interacts with virtual objects, and wherein the artificial intelligence module analyzes the user's interaction patterns to adjust the feedback intensity.

The haptic feedback generator can be configured within this embodiment to provide immediate tactile sensations in response to user actions performed within the virtual environment. It functions by constantly receiving feedback from the artificial intelligence (AI) module that can scale up or down, change its type and/or delay until vibration feedback appears to be in a responsive relationship with several different types of actions made by the user. The generator is made of a matrix of piezoelectric actuators that are integrated into hand-held controllers. These actuators move mechanically when the system is supplied with an electrical current and allowed the emulator to simulate a wide range of tactile sensations.

To create the sensation of a texture, force or resistance, you could simulate any one by controlling each actuator individually in this array. If a user reaches out to touch or manipulate an object with little surface texture—say, one that's smooth like glass rather than bumpy or ridged—the actuators can reproduce less intense forces representing those encountered on the fingertip while moving their finger across this un-textured virtual body. If the user then interacts with a rough or jagged object, those same actuators kick into gear in order to generate an increased amount of coarse feedback points which altogether recreate what it might feel like for this person subjectively to be feeling out those elements on their own skin. Likewise, when the user pushes or pulls virtual objects around, actuators are engineered to pushback with different strengths of force as one would feel in real life.

The AI module perpetually evaluates the gameplay interaction patterns of users, e. g., how often, with such force and what objects are being interacted with by reading data from controllers). From this information, the system dynamically increases/decreases feedback intensity. So, if the user does something strenuous like manipulates an object several times (say lift a heavy virtual object) and that action would increase resistance generated by those actuators to provide realistic feedback of this highly unstable environment. Similarly, when the user's interaction with an object is more subtle, the actuator intensity decreases to emulate lighter touch.

This embodiment enables highly performance and tactile (haptic response) in VR experiences that adjust real-time, more intelligent haptic based on user behaviour to make interactions with virtual objects feel more true-to-life.

In an embodiment, the inertial measurement units (IMUs) within the hand-held controllers are configured with 9 degrees of freedom (DoF) sensors, including accelerometers, gyroscopes, and magnetometers, wherein the IMUs capture fine-grained motion data at a high sampling rate, which is processed by a Kalman filter within the CPU to fuse the sensor data, eliminating noise and drift, and wherein the processed data is then transmitted to the artificial intelligence module, allowing for precise real-time tracking of hand motions and gestures, enabling the system to generate realistic feedback when the user interacts with virtual objects through force feedback mechanisms.

In an embodiment, the path optimization processor implements a continuous gradient descent technique to iteratively adjust the user's trajectory in real-time, wherein the processor continuously recalculates the gradient of the navigation path based on proximity to virtual obstacles, user gaze direction, and motion vector data, wherein the recalculated trajectory is transmitted to the dynamic path generation unit, which adjusts the virtual route by shifting waypoints within the environment to ensure smooth navigation that minimizes abrupt changes in direction or speed.

In an embodiment, the physiological monitoring unit processes heart rate data by applying a time-domain analysis to detect sudden spikes in user stress levels, wherein the analysis involves computing the root mean square of successive differences (RMSSD) in the heart rate data to determine the user's stress response, and wherein upon detecting high-stress events, the system adjusts environmental factors, such as reducing environmental complexity or altering background audio, by modifying parameters in the artificial intelligence module, thereby actively regulating the user's physiological comfort within the virtual environment.

In an embodiment, the user behaviour analysis unit further includes a machine learning-based gaze tracking system that uses pupil detection techniques, wherein said techniques process real-time gaze data by applying elliptical fitting techniques to estimate the user's point of focus within the virtual environment, and wherein the gaze tracking system dynamically adjusts the navigation prompts and visual cues within the environment based on where the user is looking, allowing the system to provide personalized guidance by highlighting relevant objects or paths according to the user's focal attention.

According to at least one embodiment, the inertial measurement units (IMUs) in hand-held controllers include a 9 degrees of freedom (DoF) sensor which comprises an accelerometer, gyroscope and magnetometer. Using these sensors, hundreds of data points are captured and at high sampling rate so the exact movements or positioning in three-dimensional space can be detected. Accelerometers picks up linear acceleration, gyroscopes measure angular velocity and magnetometer set the direction with respect to earth magnetic field. Together, this gives good tracking of many movements like rotations, tilts and translations. This motion data is then sent to the CPU and run through a Kalman filter, which combines all of this sensor input together in order to remove noise from the system as well as combat against any drift that may occur, giving you more accurate real-time tracking. The purified data is then sent to an artificial intelligence (AI) module, which makes it possible for the system to accurately recognize hand gestures and motions. This data is then fed into the controllers and used to provide lifelike force feedback, adding resistance when you grab virtual objects, ensuring both are highly manipulable.

In one example, the path optimization processor works by using a continuous gradient descent technique to adjust user trajectory in real-time. The processor constantly recalculates the gradient of the navigation path, taking into account proximity to virtual obstacles, direction of gaze and data on motion vectors. This new trajectory is then pushed into the Dynamic Path Generator which in turn creates a corrected Virtual Route by changing waypoints within the virtual environment. For instance, when there is a new obstruction in the user path, the processor will meanwhile reroute around it so that user can navigate through without sharp corners or rapid speed changes. This method will indeed improve the UX of users, providing them seamless navigation which can be real-time dependent and changes based on user behaviour.

In one embodiment, the physiological monitoring unit includes process for processing heart rate data via a time-domain analysis to detect rapid increases in stress level of the user. The calculation is based on the measure of variance in heart rate data and examination for the detection of stress responses, known as root mean square differences between adjacent R-R intervals (RMSSD). Then, when the system can see that there is a major stressful event (based on fluctuations) it adjusts environmental changes in virtual reality. For example, it might mean trimming down what's in the virtual world to avoid overwhelming sensory input or shifting background sounds around so that it's a bit more soothing. The AI module controls these variables—in real-time, to create a very relaxed and stress-free experience for the user.

According to some embodiments, the user behaviour analysis unit comprises a machine learning based gaze tracking system with uses eye detection techniques to track users' gazes. The use of these techniques consists in processing the real-time gaze data, applying elliptical fitting techniques to predict where the user has is focusing within a virtual environment. By studying the shape and movement of a user's pupil, it knows what they are looking at so can alter their surroundings accordingly. For example, the system will recognize if a user is feeling that object and may highlight it or steer navigation prompts to increase your attention. By using the user's gaze to personalize guidance, navigation paths and visual cues are dynamically adjusted according to where the user is looking—a way of delivering a more intuitive process without obstructing overall navigational capabilities or ruining immersion in virtual space.

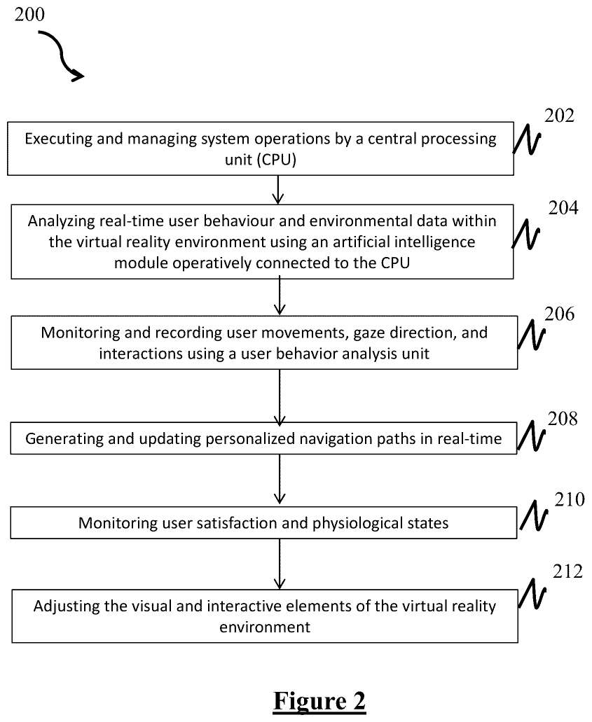

FIG. 2 provides flow chart of a method for providing AI-based intelligent virtual reality navigation to enhance user experience. The method 200 comprising the steps of:
Step 202: Executing and managing system operations by a central processing unit (CPU), wherein the CPU coordinates all data processing and communication between system components;
Step 204: Analyzing real-time user behavior and environmental data within the virtual reality environment using an artificial intelligence module operatively connected to the CPU, the module receiving input from various sensors and processing user interactions within the virtual environment;
Step 204: Monitoring and recording user movements, gaze direction, and interactions using a user behavior analysis unit, the unit comprising motion sensors, gaze trackers, and interaction data capture components, wherein the collected data is transmitted to the artificial intelligence module for analysis and interpretation of user behavior;
Step 206: Processing contextual data using a contextual data processing unit, the unit comprising environmental sensors and spatial mapping techniques, wherein the unit continuously analyzes the virtual environment's layout, object distribution, and ambient conditions, providing the artificial intelligence module with updates on changes in the environment;
Step 208: Generating and updating personalized navigation paths in real-time using a dynamic path generation unit, wherein the unit creates navigation routes based on the user's behavioral data and environmental context, and dynamically adjusts the path as new data is processed;
Step 210: Monitoring user satisfaction and physiological states using a feedback mechanism, the feedback mechanism comprising biometric sensors and user input interfaces, wherein data is collected on the user's satisfaction and physiological state, including heart rate and gaze patterns, and fed back into the artificial intelligence module for continuous optimization of the navigation experience;
Step 212: Adjusting the visual and interactive elements of the virtual reality environment using a user interface management module, the module comprising display generation and control interfaces, wherein the visual display and interaction elements are modified in real-time based on user preferences and contextual data, enhancing the immersion and overall user experience in the virtual environment.

This Intelligent Virtual Reality Navigation System Based on an AI Model is comprised of a VR navigation Device, which combines multiple components for better user experience. At the heart of it, there is a CPU loaded with AI techniques that can process machine learning and perform real-time decision making. It is this processing unit that processes the continuous stream of data coming from many sensory input modules.

The sensory input module is actually equipped with a bunch of sensors that are able to detect user movements, gazing point or even gestures and also biometric signals like heart rate and skin conductivity. Environmental information, including spatial orientation and the virtual environment itself alongside obstacles within the created virtual world is also monitored periodically.

The processing unit holds AI techniques that scan this data for patterns and predict what the user is going to say or do next. It could adjust the navigation path to guide the user more intuitively if, say, frequent looks in a particular direction or displays of bewilderment signal areas into which he is trying to navigate. The same AI can also take into account user preferences like speed and how much users want to interact with the environment.

Another crucial part of the invention is that it works through a feedback loop system. The system provides feedback as the user moves through the virtual environment, capturing behavioural insight along with motion patterns and navigation speed in decision making point-of-care techniques to incorporate biometric responses. To fine-tune the navigation system in real-time, AI techniques process this feedback for progressive user experience improvement.

A wearable VR headset is the form factor for virtual, sensory input module end (such as structure), wherein a handheld controller allows manual overrides or selective interactions within the Virtual Environment. Ergonomically designed for comfort and engineered with high-resolution displays as well as realistic surround audio, the headset has been built to be easy-to-use.

By using dual-mode gesture control, the VR navigation device omits complex buttons or joysticks for future expansion—it can pair as relative input devices efficiently that needs only one hand available; it includes wireless communication module to link with external databases, cloud servers and other instruments so that user profiles and learned navigations uploaded to share under different VR systems.

In some implementations, the AI-driven VR navigation system may be used in different types of applications including virtual tours, educational simulations and medical training. In a virtual museum visit, for instance: The system can redirect you to the part of your interest and show details about artifacts that capture your attention. The system can be tailored to an individual trainee, with the complexity of virtual scenarios increased or decreased as skills improve over time in a medical training environment.

The VR system for navigation according to the claims includes a CPU incorporating highly sophisticated AI techniques whose function is real-time processing and analysis of data streaming from various sensors. The system is based fundamentally on a series of hardware components that include VR headsets for wear, controllers handheld and an array of sensors incorporated to create in conjunction with the experience adaptive navigation personalized at virtual environments.

Fundamental to that system—with techniques made for AI-powered, in-the-moment data processing and decision-making embedded within it—is the CPU. These AI techniques keep on learning from the user interactions, preferences and compare it with virtual environment context. Such techniques have machine learning models they can use to predict the intent of a user using historical data, behavioural patterns or real-time feedback. Data such as this is fed into the CPU from a raft of sensors embedded in both VR headset and handheld controller, each returning crucial information so that AI can make informed navigation decisions.

Included in the headset are inertial measurement units (IMUs) that monitor player head & body movements with great accuracy. This data allows the system to properly mimic user physical movements in virtual space as effectively, since these IMUs are able to provide real-time information on how your body is orienting or moving.

The headset features IMUs but also eye-tracking modules that keep track the direction of a user's gaze. Using infrared sensors and cameras, these modules would track the location of where a user was looking at any moment by monitoring close to their eyes with as many as result in data set that could be fed back into their techniques. The eye-tracking data plays a vital role for the AI techniques, as it allows them to predict what is most likely in focus of their attention/intent within this virtual world. For instance, if a person stares more in some directions, then AI can understand that he or she may want to head towards that area so it shall change the navigation path.

The AI techniques take the aggregated data feed from each of these IMUs and different eye-tracking modules to develop quite a dynamic and personalized navigation experience. The system will then adapt the speed and specific movement shown in order to reduce discomfort or disorientation on behalf of the user. If the system picks up signs of motion sickness (for example, erratic head movements or an abrupt change in binocular rivalry from one eye to another) it can slow future virtual movement down and manage smoother transition rates into any scene.

A wireless handheld controller, interacting with the CPU and VR headset for navigation plus music input within that virtual world. The controller has touchpads, buttons, and gesture recognition sensors that manually manipulate movement or select objects to perform actions. The AI techniques factor in the data from the controller, combining it with input received through sensory technology implemented within the headset to higher tune navigation experience.

The system primarily offers a feedback mechanism with the VR headset itself, which features 4 haptic actuators. The actuators in this create give the user feedback that they can feel, making physical sensations connected to movements made inside of a VR world. For instance, the haptic actuators can vibrate or exert pressure when a user touches an object within the virtual space and moves it around to promote a more realistic feel. This haptic actuators feedback also goes to the AI techniques that use this information for run-time adjustment of navigation and interaction parameters.

These AI techniques are intended to run in a closed-loop system where the user feedback informs how well this navigation model performs, rewound during training every few months. It then takes this information, learns from it and adapts to a user's preferences over time in order for the technique to become smarter with each set of predictions. The system is designed to learn the driver's regular routes so that over time, it can help avoid common congestion en route.

Additionally, the AI-powered navigation system is context-aware and responds to behave differently according to certain properties of a virtual environment. E.g. When the AI sees that a virtual space is dense with enough obstacles in between, it may well slow down the user speed to ensure no collision when walking through while maintain higher precision of navigations. On the other end of that same spectrum, if one were to take an open (or simply very widely expansive) virtual environment An AI could be created which allows for fast paced movement and somewhat less limited exploration.

To sum up, this level of detail in VR navigation system description demonstrates AI techniques becoming an adjunct to processor systems reading the immediacy data from IMUs or visual input signals (eye tracking modules and gesture recognition sensors). The goal of the system is to improve our current navigator 2.0 into more dynamic, adaptive and personalized navigation systems by continuously learning from user interactions and environmental context in a virtual setting? The feedback mechanism, including haptic actuators provides a level of immersion and realism to the VR experience that is a substantial improvement over other existing solutions for navigating in VR.

The present invention relates to the field of virtual reality (VR) technology and, more particularly, to systems and methods for navigating through a rendered environment. Its vision is to merge artificial intelligence (AI) technology with VR hardware such as headsets, sensors and controllers resulting in an intelligent, adaptable personalized navigation solution. The invention can be applied on any business field such as game, educational purpose, health care etc., wherever more interaction is needed from user and immersive experience are important.

We claim:

1. A system for providing an AI-based intelligent virtual reality navigation system to enhance user experience, the system comprising:
a central processing unit (CPU) configured to execute and manage operations within the system;
an artificial intelligence module operatively connected to the CPU and configured to analyze real-time user behavior and environmental data within the virtual reality environment;
a user behavior analysis unit operatively connected to the artificial intelligence module, the unit comprising motion sensors, gaze trackers, and interaction data capture components, wherein the user behavior analysis unit is configured to monitor and record the user's movements, gaze direction, and interactions within the virtual environment;
a contextual data processing unit operatively connected to the artificial intelligence module, the unit comprising environmental sensors and spatial mapping techniques configured to analyze the virtual environment's layout, object distribution, and ambient conditions;
a dynamic path generation unit operatively connected to the artificial intelligence module, configured to create and update in real-time, personalized navigation paths based on the analyzed user behavior and contextual data;
a feedback mechanism operatively connected to the dynamic path generation unit, comprising biometric sensors and user input interfaces configured to monitor user satisfaction and feed data back into the artificial intelligence module for continuous adaptation of the navigation strategy; and
a user interface management module operatively connected to the CPU, comprising display generation and control interfaces configured to present the virtual reality environment to the user, adjusting visual and interactive elements based on user preferences and real-time contextual analysis.

2. The system of claim 1, wherein the artificial intelligence module further comprises machine learning techniques configured to learn from historical user interaction patterns, thereby enhancing the system's ability to predict user preferences and optimize future navigation paths within the virtual reality environment, the machine learning techniques being stored in a non-transitory memory component operatively connected to the CPU.

3. The system of claim 1, wherein the user behavior analysis unit further comprises a neural network processor configured to process and analyze complex behavioral patterns in real-time, the neural network processor being operatively connected to the CPU and configured to communicate with the artificial intelligence module to refine the understanding of user intentions within the virtual environment.

4. The system of claim 1, wherein the contextual data processing unit further comprises a three-dimensional (3D) spatial mapping sensor array configured to capture and analyze the spatial relationships between objects within the virtual environment, the 3D spatial mapping sensor array being operatively connected to the CPU and the artificial intelligence module to provide real-time updates to the dynamic path generation unit.

5. The system of claim 1, wherein the dynamic path generation unit further comprises a path optimization processor configured to analyze potential navigation routes based on user behavior and environmental context, the path optimization processor being operatively connected to the artificial intelligence module and configured to dynamically adjust the user's navigation trajectory to avoid obstacles, minimize disorientation, and optimize the user's overall experience within the virtual environment.

6. The system of claim 1, wherein the feedback mechanism further comprises a physiological monitoring unit, including heart rate monitors, eye movement trackers, and galvanic skin response sensors, the physiological monitoring unit being operatively connected to the CPU and the artificial intelligence module to provide real-time feedback on the user's physiological state, enabling the system to adjust navigation paths and environmental conditions to enhance user comfort and reduce stress during the VR experience.

7. The system of claim 1, wherein the user interface management module further comprises a haptic feedback generator operatively connected to the CPU and configured to provide tactile feedback to the user through hand-held controllers, the haptic feedback generator being controlled by the artificial intelligence module to enhance the immersive quality of the navigation experience by simulating physical interactions with virtual objects.

8. The system of claim 1, wherein the central processing unit (CPU) further comprises a multi-core processor architecture, the multi-core processor architecture being configured to independently handle parallel processing tasks including user behavior analysis, contextual data processing, dynamic path generation, and user interface management, thereby ensuring real-time responsiveness and smooth operation of the AI-based intelligent virtual reality navigation system.

9. The system of claim 1, wherein the virtual reality headset comprises integrated displays with a high refresh rate and wide field of view, operatively connected to the CPU and user interface management module, the displays being configured to present a stereoscopic view of the virtual environment, thereby enhancing the immersive quality of the navigation experience, and further comprising motion sensors embedded within the headset to track head movements and adjust the visual display accordingly.

10. The system of claim 1, wherein the hand-held controllers further comprise inertial measurement units (IMUs) and force feedback mechanisms, operatively connected to the CPU and haptic feedback generator, the hand-held controllers being configured to allow the user to interact with virtual objects through gestures and button inputs, with the force feedback mechanisms providing resistance and tactile sensations corresponding to the virtual interactions, thereby enhancing the realism of the navigation experience within the virtual environment.

11. The system of claim 2, wherein the machine learning techniques are executed within a dedicated neural processing unit (NPU), configured to handle tensor operations by parallelizing the data across multiple cores, wherein the NPU processes real-time user interaction data by partitioning it into mini-batches, applying gradient-based optimization techniques to update navigation models without interrupting the system's primary processing tasks, and wherein the NPU directly communicates with the CPU through a high-speed bus, enabling continuous learning and path prediction adjustments based on dynamic changes in user behavior patterns.

12. The system of claim 3, wherein the neural network processor operates using a specialized memory hierarchy that stores user movement and gaze data in a cache memory system, wherein said memory system is structured to pre-load relevant data chunks, reducing latency in real-time processing, wherein the processor first performs time-based segmentation of the user's movement data and applies a series of non-linear transformations through activation functions designed to detect subtle variations in user intent, including, slight head tilts or micro-gestures.

13. The system of claim 4, wherein the 3D spatial mapping sensor array uses structured light projection to create a high-density point cloud representation of the virtual space, wherein the array includes time-of-flight (ToF) sensors that measure the distance between objects by calculating the time delay of the reflected light, wherein the point cloud data is then processed by the contextual data processing unit, which applies a voxel-based filtering technique to eliminate noise from the point cloud, ensuring that only relevant environmental changes, including moving obstacles or altered lighting conditions, are fed to the dynamic path generation unit for real-time adjustment of user paths.

14. The system of claim 5, wherein the path optimization processor operates by analyzing navigation routes within a dedicated co-processor by segmenting the virtual environment into a graph of nodes and edges representing possible movement paths, wherein the processor applies heuristic weightings to each edge, prioritizing paths that minimize the user's visual confusion by avoiding complex intersections or sudden directional changes, and wherein the weightings are continuously updated based on incoming user data, ensuring real-time recalculations of optimal navigation routes in response to user behavior and environmental changes.

15. The system of claim 6, wherein the physiological monitoring unit uses a series of embedded sensors within a wearable device, such as a wristband, to capture biometric data, including heart rate variability and galvanic skin response, wherein the data is processed using a fast Fourier transform (FFT) to isolate stress-related physiological signals, which are then cross-referenced with user behavior patterns, and wherein the artificial intelligence module uses this physiological data to dynamically adjust both the virtual environment and the navigation paths by modulating environmental lighting, sound intensity, and navigation speed to enhance user comfort and reduce stress.

16. The system of claim 7, wherein the haptic feedback generator operates by receiving real-time input from the artificial intelligence module, which dynamically adjusts the intensity and type of haptic feedback based on user interactions, wherein the generator uses a piezoelectric actuator array embedded in hand-held controllers, wherein each actuator is independently controlled to simulate varying textures, forces, and resistances when the user interacts with virtual objects, and wherein the artificial intelligence module analyzes the user's interaction patterns to adjust the feedback intensity.

17. The system of claim 10, wherein the inertial measurement units (IMUs) within the hand-held controllers are configured with 9 degrees of freedom (DoF) sensors, including accelerometers, gyroscopes, and magnetometers, wherein the IMUs capture fine-grained motion data at a high sampling rate, which is processed by a Kalman filter within the CPU to fuse the sensor data, eliminating noise and drift, and wherein the processed data is then transmitted to the artificial intelligence module, allowing for precise real-time tracking of hand motions and gestures, enabling the system to generate realistic feedback when the user interacts with virtual objects through force feedback mechanisms.

18. The system of claim 5, wherein the path optimization processor implements a continuous gradient descent technique to iteratively adjust the user's trajectory in real-time, wherein the processor continuously recalculates the gradient of the navigation path based on proximity to virtual obstacles, user gaze direction, and motion vector data, wherein the recalculated trajectory is transmitted to the dynamic path generation unit, which adjusts the virtual route by shifting waypoints within the environment to ensure smooth navigation that minimizes abrupt changes in direction or speed.

19. The system of claim 6, wherein the physiological monitoring unit processes heart rate data by applying a time-domain analysis to detect sudden spikes in user stress levels, wherein the analysis involves computing the root mean square of successive differences (RMSSD) in the heart rate data to determine the user's stress response, and wherein upon detecting high-stress events, the system adjusts environmental factors, such as reducing environmental complexity or altering background audio, by modifying parameters in the artificial intelligence module, thereby actively regulating the user's physiological comfort within the virtual environment.

20. The system of claim 1, wherein the user behavior analysis unit further includes a machine learning-based gaze tracking system that uses pupil detection techniques, wherein said techniques process real-time gaze data by applying elliptical fitting techniques to estimate the user's point of focus within the virtual environment, and wherein the gaze tracking system dynamically adjusts the navigation prompts and visual cues within the environment based on where the user is looking, allowing the system to provide personalized guidance by highlighting relevant objects or paths according to the user's focal attention.
